(19) United States
(12) Patent Application Publication
(10) Pub. No.: US 2020/0111076 A1
(43) Pub. Date: Apr. 9, 2020

(54) METHODS, APPARATUSES, AND COMPUTER PROGRAM PRODUCTS FOR USING AN AUTHENTICATED TELEPHONE NUMBER TO TRANSFER GOODS AND SERVICES TO DESIGNATED RECIPIENTS

(71) Applicant: AVERON US, INC., Henderson, NV (US)

(72) Inventors: Wendell Brown, Henderson, NV (US); Mark Klein, Henderson, CA (US)

(21) Appl. No.: 16/595,326

(22) Filed: Oct. 7, 2019

Related U.S. Application Data
(60) Provisional application No. 62/742,201, filed on Oct. 5, 2018.

(51) Int. Cl. G06Q 20/32; G06Q 30/02; G06Q 30/06; H04W 12/08

(52) U.S. Cl. CPC G06Q 20/325; G06Q 30/0235; H04W 12/08; G06Q 30/0617; G06Q 20/3224

(57) ABSTRACT

Various embodiments of the present disclosure are directed to providing authorized redemption of a redemption code and, specifically to an apparatus for receiving, from a fulfillment entity, an authorization request indicative of a redemption request received at the fulfillment entity requesting authorization to redeem the redemption code and in response to the authorization request, providing a network address to a redeeming device. The apparatus is further configured to receive, from a network device associated with a mobile carrier, at least one identification parameter associated with the redeeming device upon the redeeming device accessing the network address and determine whether the at least one identification parameter associated with the redeeming device satisfies the at least one qualification requirement. In an instance the identification parameter satisfies the qualification requirement, prompting the fulfillment entity to allow redemption of the redemption code.

### CROSS REFERENCE TO RELATED APPLICATIONS

This application claims priority to U.S. Provisional Application No. 62/742,201, filed Oct. 5, 2018, the entire contents of which are incorporated herein by reference.

### TECHNOLOGICAL FIELD

Embodiments described herein generally relate to techniques for programmatically managing the redemption of promotions (e.g., incentives, goods, services, and/or experiences) and ensuring that only authorized consumers receive the promotions. In particular, embodiments described herein relate to providing authentication of redemption requests while reducing user input and, specifically to a method, apparatus, and computer program product for receiving at least one identification parameter and in an instance the identification parameter satisfies the qualification requirement, prompting a fulfillment entity to allow redemption of the promotion.

### BACKGROUND

Traditionally, promotions or offers are posted on the web, sent via email, shared via social media, or shared via other distribution methods to unauthorized recipients due to lack of security. With these security issues, third-party entities and fulfillment parties are reluctant to utilize digital promotions which also adversely affects consumers as well by decreasing the number of digital promotions that third-party entities issue or make available to consumers.

In this regard, areas for improving known, existing and/or conventional authentication systems have been identified. Through applied effort, ingenuity, and innovation, solutions to improve such systems have been realized and are described in connection with embodiments of the present invention.

### BRIEF SUMMARY

A computer-implemented method is provided for storing information indicative of a redemption code, the redemption code associated with at least one qualification requirement, wherein the at least one qualification requirement indicates that a third-party entity has authorized redemption of the redemption code by a second entity, the second entity being an intended recipient device. The computer-implemented method further comprises receiving, from a fulfillment entity, an authorization request indicative of a redemption request received at the fulfillment entity requesting authorization to redeem the redemption code, and in response to the authorization request, the computer-implemented method further comprises providing a network address to a redeeming device, and receiving, from a network device associated with a mobile carrier, at least one identification parameter associated with the redeeming device upon the redeeming device accessing the network address. In some embodiments, the computer-implemented method further comprises determining whether the at least one identification parameter associated with the redeeming device satisfies the at least one qualification requirement and in an instance the identification parameter satisfies the qualification requirement, the computer-implemented method further comprises prompting the fulfillment entity to allow redemption of the redemption code and in an instance the identification parameter does not satisfy the qualification requirement, the computer-implemented method is further configured to prompt the fulfillment entity to prohibit redemption of the redemption code

In some embodiments, the at least one qualification requirement and the at least one identification parameter is at least one of a telephone number, a device serial number, a unique serial number (ICCID), an international mobile subscriber identity (IMSI) number, an International Mobile Equipment Identity (IMEI), or a location of the second entity. In some embodiments the network address is a uniform resource locator (URL) address.

In some embodiments, the computer-implemented method includes receiving redemption policy information from the third-party entity and determining whether to prompt the fulfillment entity to allow redemption of the redemption code or prohibit redemption of the redemption code based at least in part on the redemption policy information set by the third-party entity. In some embodiments, the redemption policy information set by the third-party entity comprises a time frame and/or geographic location within which the redemption code can be redeemed.

The method further includes upon prompting the fulfillment entity to allow redemption of the redemption code, accessing payment information associated with the third-party entity and processing a payment transaction using the payment information associated with the third-party entity, wherein payment will be made to the fulfillment entity on behalf of the intended recipient. In an example embodiment, wherein determining whether the identification parameter associated with the redeeming device satisfies the qualification requirement further comprises performing a matching process between the qualification parameter provided by the third-party entity identifying the intended recipient and the identification parameter associated with the redeeming device upon the redeeming device accessing the network address.

In another example embodiment, an apparatus is provided comprising at least one processor and at least one memory including computer program code, the at least one memory and the computer program code configured to, with the processor, cause the apparatus to at least: store information indicative of a redemption code, the redemption code associated with at least one qualification requirement, wherein the at least one qualification requirement indicates that a third-party entity has authorized redemption of the redemption code by a second entity, the second entity being an intended recipient device. The apparatus if further configured to receive, from a fulfillment entity, an authorization request indicative of a redemption request received at the fulfillment entity requesting authorization to redeem the redemption code, and in response to the authorization request, the apparatus is further configured to provide a network address to a redeeming device and receive, from a network device associated with a mobile carrier, at least one identification parameter associated with the redeeming device upon the redeeming device accessing the network address. The apparatus is then configured to determine whether the at least one identification parameter associated with the redeeming device satisfies the at least one qualification requirement. In an instance the identification parameter satisfies the qualification requirement, the apparatus is configured to prompt the fulfillment entity to allow redemption of the redemption code and in an instance the identification parameter does not satisfy the qualification requirement, the apparatus is configured to prompt the fulfillment entity to prohibit redemption of the redemption code.

In some embodiments, the at least one qualification requirement and the at least one identification parameter is at least one of a telephone number, a device serial number, a unique serial number (ICCID), an international mobile subscriber identity (IMSI) number, an International Mobile Equipment Identity (IMEI), or a location of the second entity. In some embodiments the network address is a uniform resource locator (URL) address.

In some embodiments, the apparatus is further configured to receive redemption policy information from the third-party entity and determine whether to prompt the fulfillment entity to allow redemption of the redemption code or prohibit redemption of the redemption code based at least in part on the redemption policy information set by the third-party entity. In some embodiments, the redemption policy information set by the third-party entity comprises a time frame and/or geographic location within which the redemption code can be redeemed.

The apparatus is further configured to prompt the fulfillment entity to allow redemption of the redemption code, access payment information associated with the third-party entity and process a payment transaction using the payment information associated with the third-party entity, wherein payment will be made to the fulfillment entity on behalf of the intended recipient. In an example embodiment, the apparatus is further configured to perform a matching process between the qualification parameter provided by the third-party entity identifying the intended recipient and the identification parameter associated with the redeeming device upon the redeeming device accessing the network address.

In yet another example embodiment, a computer program product comprising at least one non-transitory computer-readable storage medium having computer-executable program code instructions stored therein, the computer-executable program code instructions comprising program code instructions for storing information indicative of a redemption code, the redemption code associated with at least one qualification requirement, wherein the at least one qualification requirement indicates that a third-party entity has authorized redemption of the redemption code by a second entity, the second entity being an intended recipient device, receiving, from a fulfillment entity, an authorization request indicative of a redemption request received at the fulfillment entity requesting authorization to redeem the redemption code. In response to the authorization request, the computer program product further comprises program code instructions for providing a network address to a redeeming device and for receiving, from a network device associated with a mobile carrier, at least one identification parameter associated with the redeeming device upon the redeeming device accessing the network address, and for determining whether the at least one identification parameter associated with the redeeming device satisfies the at least one qualification requirement. In an instance the identification parameter satisfies the qualification requirement, the computer program product is further configured to prompt the fulfillment entity to allow redemption of the redemption code and in an instance the identification parameter does not satisfy the qualification requirement, the computer program product is further configured to prompt the fulfillment entity to prohibit redemption of the redemption code.

In some embodiments, the at least one qualification requirement and the at least one identification parameter is at least one of a telephone number, a device serial number, a unique serial number (ICCID), an international mobile subscriber identity (IMSI) number, an International Mobile Equipment Identity (IMEI), or a location of the second entity. In some embodiments the network address is a uniform resource locator (URL) address.

In some embodiments, the computer-executable program code instructions further comprise program code instructions for receiving redemption policy information from the third-party entity and determining whether to prompt the fulfillment entity to allow redemption of the redemption code or prohibit redemption of the redemption code based at least in part on the redemption policy information set by the third-party entity. In some embodiments, the redemption policy information set by the third-party entity comprises a time frame and/or geographic location within which the redemption code can be redeemed.

In another example embodiment, the computer-executable program code instructions further comprise program code instructions for prompting the fulfillment entity to allow redemption of the redemption code, accessing payment information associated with the third-party entity and processing a payment transaction using the payment information associated with the third-party entity, wherein payment will be made to the fulfillment entity on behalf of the intended recipient. In an example embodiment, wherein determining whether the identification parameter associated with the redeeming device satisfies the qualification requirement further comprises performing a matching process between the qualification parameter provided by the third-party entity identifying the intended recipient and the identification parameter associated with the redeeming device upon the redeeming device accessing the network address.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram of a system that may be specifically configured in accordance with an example embodiment of the present invention;

FIG. 2 is a block diagram of an apparatus that may be specifically configured in accordance with an example embodiment of the present invention;

FIG. 3 is a data flow diagram, showing an exemplary operation of an example system in accordance with an embodiment of the present invention; and

FIGS. 4-6 depict flowcharts, each showing an exemplary method of operating an example apparatus in accordance with an embodiment of the present invention.

### DETAILED DESCRIPTION

Some example embodiments will now be described more fully hereinafter with reference to the accompanying drawings, in which some, but not all embodiments are shown. Indeed, the example embodiments may take many different forms and should not be construed as limited to the embodiments set forth herein; rather, these embodiments are provided so that this disclosure will satisfy applicable legal requirements. Like reference numerals refer to like elements throughout.

### Terms

As used herein, the terms “data,” “content,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to the other computing device or may be sent indirectly via one or more intermediary computing devices, such as, for example, one or more servers, relays, routers, network access points, base stations, hosts, and/or the like.

Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

The term “service provider” refers to any web service application or a network-connected entity, such as business, merchant, organization, administration, or other provider that provides products and/or services to a user of a mobile device. For example, a service provider may be businesses that provide web servers, web pages, transactional applications to sell products or services, and data to facilitate transactions.

The term “mobile device” refers to computer hardware and/or software that is configured to access a service made available by a service provider. Mobile devices may include, without limitation, smart phones, tablet computers, laptop computers, wearables, personal computers, enterprise computers, and the like. The mobile devices described herein communicate with one or more systems or servers, for example an authentication system via one or more communication network(s).

The term “identification parameter” as used herein refers to any information that may identify a mobile device, user, or entity. For example, identification information may refer to a telephone number, a device serial number, a unique serial number (ICCID), an international mobile subscriber identity (IMSI) number, an International Mobile Equipment Identity (IMEI), or a location of the mobile device or entity. Identification information may be stored, transmitted, and/or received, in some embodiments, in a hashed, one-way hashed, encrypted, digitally signed, using public/private key encryption or other means of encrypting, or other similar algorithms (e.g., for system/customer/bank/wireless network/other privacy or other reasons) data form.

The term “account information” as used herein refers to a user's mobile device account information, which may be similar or the same as a mobile device's phone number/CallerID number, the mobile device's phone number, the mobile device's callerID number, International Mobile Equipment Identity (IMEI)/unique serial number (ICCID)data, network-based, MAC addresses, billing record's modem certificate, DOCSIS hub/Media Access Layer routing assignments, Cable modem's certificate, device serial number, etc., Intel vPro and Trusted Platform Module key, or the like.

The terms “third-party”, “telecommunications carrier” or “network provider” as used herein may be, for example, wireless network provider or carrier (e.g., Verizon, AT&T, T-Mobile, etc.) which may have data such as a user's name, billing address, equipment installation address, birthdate, tower routing/router information to the user's wireless device (e.g., mobile phone), IP WAN address, IP LAN address, IP DMZ info, wireless device equipment information (serial number, certificate number, model number, IMEI number etc.), and other information, that it could similarly supply to a third-party.

The terms “authentication and redemption system” or “authentication and redemption service” may include a system/service that is accessible via one or more computing devices and that is operable to provide redemption codes and/or authentication services on behalf of one or more third-party entities that are offering one or more redemption codes that are redeemable for goods, services, experiences and/or the like. In some examples, the authentication and redemption system may take the form of a redemption authority, a payment processor, a rewards provider, an entity in a financial network, a promoter, an agent and/or the like. As such, the service is, in some example embodiments, configured to store one or more redemption codes, accept payments for the redemption codes from third-party entities, participate in redemption, authorize redemption transactions, provide payment to fulfillment entities and/or or otherwise participate in the transaction of promotions, goods, services or experiences for currency, value and/or the like. The service is also, in some example embodiments, configured to offer services such as redemption code building (e.g., assisting third-party entities with selecting parameters for newly created redemption codes), promotion/redemption code analytics (e.g., offering information to third-party entities to provide data and analysis regarding the costs and return-on-investment associated with offering promotions or redemption codes), and the like.

In another example, the authentication and redemption system refers to computing hardware, circuitry, server, device, system, or sub-system configured to verify the identity of a user associated with a mobile device, or the identity of the mobile device. In some embodiments, the authentication and redemption system is configured to receive mobile device identification information. In some embodiments, the authentication and redemption system automatically verifies received mobile device identification information. In some embodiments, received mobile device identification information is compared to stored information to determine whether the information matches and in an instance when there is a match, the authentication system is configured to transmit a signal, to prompt a fulfillment party or service provider to allow the mobile device to redeem the redemption code provided by a third-party entity and fulfilled by the service provider and/or fulfillment party.

The term “header enrichment” refers to a process for authenticating a mobile device or an owner of the mobile device via a Direct Autonomous Authentication process, involving a packet header enrichment in which packet headers comprise device identification information, for example, “injected” therein by a trusted party such as a telecommunications carrier, network provider or through a login process. For example, in some embodiments, a network may inject a phone number associated with a mobile device within packet headers. In this manner, the authentication system may obtain device identification information without user input. application Ser. No. 15/424,595, entitled “Method and Apparatus for Facilitating Frictionless Two-Factor Authentication,” filed on Feb. 3, 2017, which is hereby incorporated by reference in its entirety, describes a number of exemplary processes for performing a Direct Autonomous Authentication process.

As used herein, a “third-party entity” provides payment for an intended recipient. For example, a “third-party entity” may include, but is not limited to, a business owner, consigner, shopkeeper, tradesperson, vendor, operator, entrepreneur, agent, dealer, organization or the like.

As used herein, the term “intended recipient” should be understood to refer to a intended recipient of goods, services, promotions, media, or the like provided by the “fulfillment party” and paid for by the “third-party entity”. an intended recipient may include, without limitation, individuals, groups of individuals, corporations, and the like.

As used herein, the term “fulfillment party,” should be understood to refer to a fulfiller, supplier, or deliverer of goods, services, promotions, media, or the like. A fulfillment party or entity may include, without limitation, an individual, a business, or the like.

As used herein, the term “redemption code” may include, but is not limited to, any type of offered, presented or otherwise indicated reward, discount, coupon, credit, deal, incentive, media or the like that is indicative of a prepaid or negotiated value or the like that upon redemption results in the use, access to, or issuance of particular goods, services and/or experiences.

As used herein, the term “redemption” refers to the use, exchange or other presentation of a redemption code for at least a portion of the value of the use, access to, or issuance of a good, service or experience. An example of redemption may include providing a redemption code in lieu of providing payment or payment information to ride-share service in exchange for a ride.

As used herein, the term “location data” refers to electronic information indicating a particular location. In some embodiments, location data indicative of a current location of a mobile device may be provided by a location services module of the mobile device. In some embodiments, location data may be provided by a fulfillment party indicating the location of consumers or consumer devices within their location. It should be appreciated that location data may be provided by various systems capable of determining location information, including, but not limited to, global positioning service receivers, indoor navigation systems, cellular tower triangulation techniques, video surveillance systems, or radio frequency identification (RFID) location systems.

As used herein, the term “redemption policy information” refers to terms and conditions under which the redemption code is offered. The redemption policy information may include parameters, bounds, considerations and/or the like that outline or otherwise define the terms, timing, constraints, limitations, rules or the like under which the redemption code is sold, offered, marketed, or otherwise provided to an intended recipient.

In some examples, a redemption code may include a qualification requirement. As used herein, a “qualification requirement” may include any conditions required by the authentication and redemption service to be satisfied in order for a particular consumer to redeem a redemption code. For example, the third-party entity may include the phone number associated with an intended recipient as a qualification requirement, such that when a particular consumer, via a particular mobile device, attempts to utilize a redemption code at a fulfillment entity, the fulfillment entity may utilize the authentication and redemption service to authenticate identify the phone number of the particular mobile device and authorize, or otherwise prompt the fulfillment party to authorize use of the redemption code upon confirmation that the phone number of the particular mobile device matches the phone number associated with the intended recipient. In this regard, the qualification requirement may be associated with a redemption code such redemption may only be permitted in instances that the qualification requirement is satisfied. that is, as described above, a qualification requirement may relate to a consumer, such as the consumer must be identified as a qualified consumer based on a unique identifier of the consumer. Additionally or alternatively, a qualification requirement may be dependent on location data, such as the location of a mobile device attempting to redeem the redemption code being in a specified location and/or within a specified distance of the third-party entity (e.g., bar, restaurant, etc.). In yet another example embodiment, the qualification requirement may indicative of a time frame within which the redemption code may be redeemed.

### Overview

One of the most popular methods for distributing coupons is via electronic communications (e.g., email, text message, etc.). Unfortunately, electronic communications are often forwarded to unintended recipients. Conventional systems are unable to confirm that a redeeming device (e.g., mobile device attempting to redeem, for example, a coupon or discount code) was the intended recipient device of the electronic communication, for example, of the coupon or discount code. Embodiments described herein provide a system in which a third-party entity can pay (e.g., in full or partially) for a good, service, etc. of another (e.g., a customer or “intended recipient”) by associating the payment of the good, service, etc. with identification information of the intended recipient, a mobile device associated with the intended recipient, or account associated with the intended recipient. For example, in some embodiments, a system may be provided that links a third-party payment for a transferred item to a phone number of a phone of an intended recipient. Upon redemption, the system authenticates the phone number of the phone before authorizing the redemption by the fulfilling party to confirm that the redeeming party is the intended recipient.

In an exemplary embodiment, a third-party entity (e.g., a repair shop, bar, hospital, etc.) provides an authentication system with information to credit the phone number of the recipient with an item. The authentication system manages the redemption of the item using the phone number authentication capabilities of the authentication system. The authentication system implements the policies of the third-party entity regarding the redemption of the item. In a ride sharing example, a set of policies for a specific item transfer might be, “You are granted two rides of up to 20 miles. One ride must be redeemed today. The second ride must terminate within 1 mile of the location of the entity.”

For exercising redemption rights, such users need to authenticate themselves. The most known and commonly-used method for user authentication is based on entering a username and a password. This may require a user to manage many different passwords for the service providers, systems, and applications they regularly use, leading to password fatigue, wasted time entering and reentering credentials, and additional time related to reaching out to technology resources to recover and/or reset lost credentials. Additionally, with the growing rate and sophistication of fraud, conventional username and password authentication is not considered safe, since the data can be easily intercepted through the communication network, and then be reused by an attacker for false representation of the original user's identity and rights. Conventional two-factor authentication may help, but is full of friction—a user probably may have their username and password saved, but conventional two-factor authentication requires them to wait for a code and then input the code before having access.

Some embodiments of the present disclosure provide frictionless authentication with telecommunications carrier provided identification, to authenticate the mobile before, for example, allowing redemption of, for example, a ride sharing service provided by a merchant.

In an example embodiment, the authentication and redemption system receives, from the mobile device, identification information associated with the mobile device comprising account information provided by a telecommunications carrier associated with the mobile device. The account information may include a telephone number or other unique identifier. Upon receiving, for example, a redemption and/or authentication request, the authentication and redemption system may then access its registry to verify the information. Once verified, the authentication and redemption system may then prompt the fulfillment party to enable redemption and/or grant the one or more services identified via the redemption code.

### System Architecture

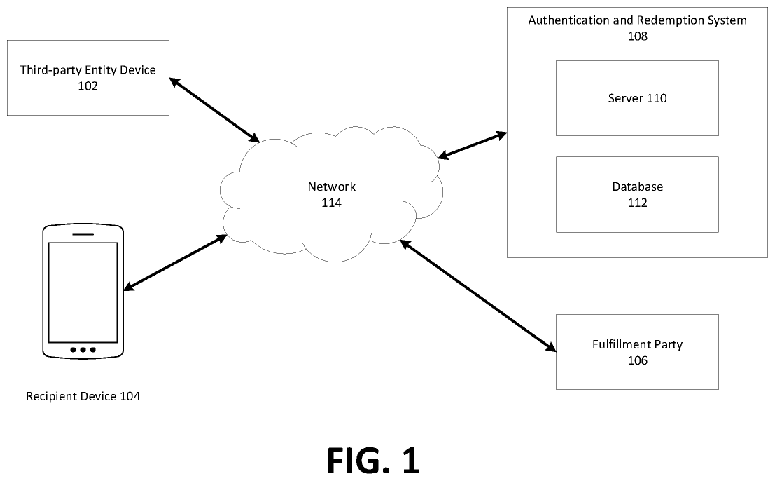

FIG. 1 is a system diagram showing an exemplary system, which may include one or more devices and sub-systems that are configured to implement embodiments discussed herein. Turning to the FIG. 1, the system may include a third-party entity device 102 (e.g., a device from which third-party payment for a good, service, etc. is offered/provided), recipient device 104 (e.g., an intended device, such as the mobile phone of the intended recipient, consumer, customer, etc.), fulfillment party 106, and authentication and redemption system 108. The authentication and redemption system 108 may comprise a server 110 and database 112. Third-party entity device 102, recipient device 104, fulfillment party 106, and authentication and redemption system 108, may include any suitable network server and/or other type of processing device to communicate with other devices via one or more networks, such as the third-party entity device 102, recipient device 104, fulfillment party 106, or authentication and redemption system 108.

Third-party entity device 102 may be configured to communicate with the authentication and redemption system 108 over a network, such as network 114, which may be the Internet or the like. The authentication and redemption system 108 may be configured to communication with the fulfillment party 106 over network 120. recipient device 104 may be configured to communicate with the authentication and redemption system 108 over a network, such as network 114.

In some embodiments, the server 110 may be configured to link, associate, and/or store an association between a third-party payment provided by or issued by the third-party entity device 102 to at least one qualification requirement, such as at least one identification parameter received over network 114 from recipient device 104. In an example embodiment, server 110 may include, for example, a registry. Server 110 may be configured to store at least one qualification requirement associated with a promotion, such as, for example, a telephone number, a device serial number, a unique serial number (ICCID), an international mobile subscriber identity (IMSI) number, an International Mobile Equipment Identity (IMEI), or a location of the second entity, in a registry of database 112 of the authentication and redemption system 108.

Database 112 comprises the registry which includes hardware and software configured to facilitate storage of a registered account and data associated with a user of the registered account (e.g., third-party entity, fulfillment party, etc.). In an example embodiment, the registry further facilitates storage of promotion information linked to the registered account and data associated with a user of the registered account. Additionally or alternatively, the registry may be configured to store additional information, such as a session id associated with the recipient device 104, linked to identification information. Database 112 may receive information via a network interface provided by the communications module 206. However, it should also be appreciated that, in some embodiments, the database 112 may include a separate processor, specially configured field programmable gate array (FPA), or application specific interface circuit (ASIC) to perform the reception of information to be stored in the registry. Database 112 is therefore implemented using hardware components of the apparatus configured by either hardware or software for implementing these planned functions.

Database 112 further includes hardware and software configured to facilitate storage, safeguarding, and management of digital keys linked to the registered account. Additionally or alternatively, database 112 may be configured to store a private key linked to a registered account. In some embodiments, database 112 is configured to facilitate storage of identity verification documents, images of identity verification documents, and/or other files representing identity verification documents. Documents and/or files may be stored in the database 112 linked to the registered account. Additionally or alternatively, database 112 may be configured to add, delete, or release stored identity verification documents, images of identity verification documents, and/or other files representing identity verification documents to third-parties. As will be appreciated, any such computer program instructions and/or other type of code may be loaded onto a computer, processor, or other programmable apparatus' circuitry to produce a machine, such that the computer, processor other programmable circuitry that execute the code on the machine created the means for implementing various functions, including those described herein.

In some embodiments, the components illustrated and described above may be configured to implement multiple operations in accordance with example embodiments of the present invention. For example, the server 110 may be configured to receive, from a fulfillment party 106, an indication of an authorization request received at the fulfillment party 106 requesting authorization for the recipient device 104 to redeem the redemption code issued by the third-party entity device 102. In response to receiving the authorization request, the server 110 may be configured to provide a network address to the recipient device 104 in order to verify that the recipient device 104 is authorized to redeem the promotion. In other words, the server 110 is configured to determine whether the third-party entity device 102 has indeed authorized redemption of the redemption code by the recipient device 104. In an example embodiment, the server 110 is configured to receive, from the recipient device 104 at least one identification parameter associated with the recipient device 104 upon the recipient device 104 accessing the network address. The server 110 is then configured to determine whether the at least one identification parameter associated with the recipient device 104 satisfies the at least one qualification requirement, wherein the at least one qualification requirement indicates that the third-party entity has authorized redemption of the redemption code by an intended recipient device. In an example embodiment, the at least one qualification requirement and the at least one identification parameter is at least one of a telephone number, a device serial number, a unique serial number (ICCID), an international mobile subscriber identity (IMSI) number, an International Mobile Equipment Identity (IMEI), or a location of the recipient device 104. In an example embodiment the at least one qualification requirement is stored in a registry of database 112. Additionally or alternatively, the at least one qualification requirement is stored in a database or repository of the third-party entity device 102.

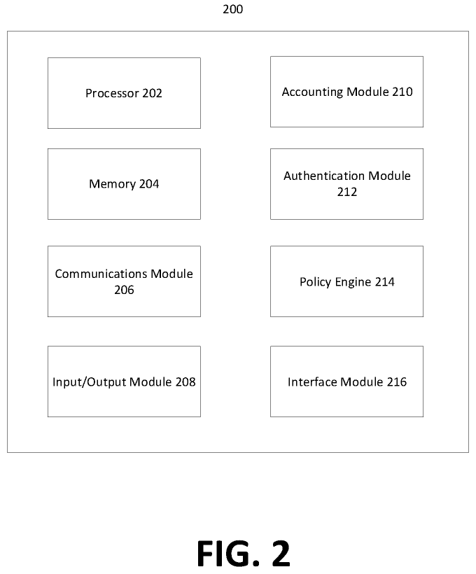

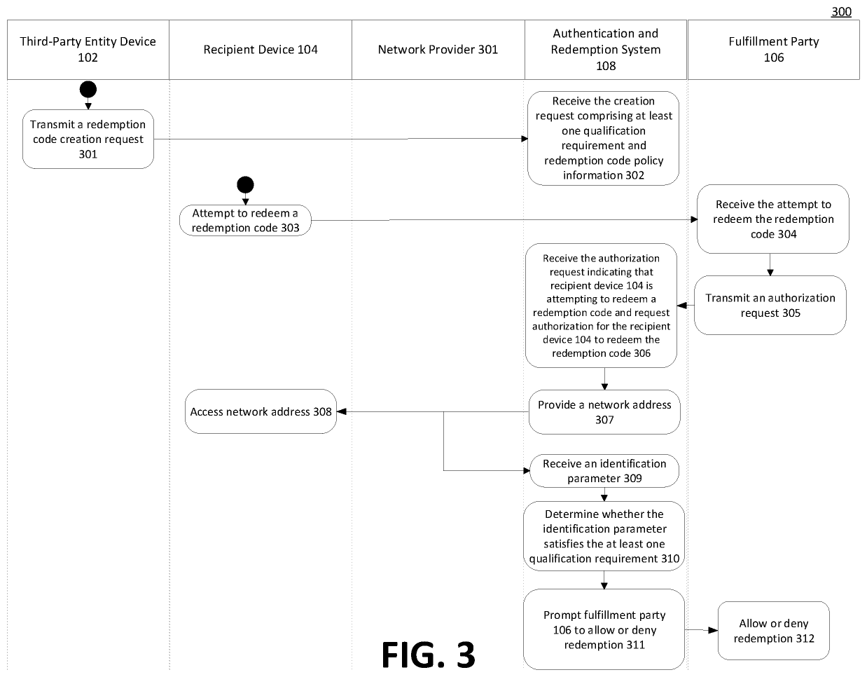

Server 110 may be embodied by one or more computing systems, such as apparatus 200 shown in FIG. 2. As illustrated in FIG. 2, the apparatus 200 may include a processor 202, a memory 204, a communications module 206, input/output module 208, accounting module 210, authentication module 212, policy engine 214, and interface module 216. The apparatus 200 may be configured to execute the operations below with respect to FIGS. 3-6. Although these modules and/or components 202-216 are described with respect to functional limitations, it should be understood that particular implementations necessarily include the use of particular hardware. It should also be understood that certain of these modules and/or components 202-216 may include similar or common hardware. For example, two sets of circuitry may both leverage use of the same processor, network interface, storage medium, or the like to perform their associated functions, such that duplicate hardware is not required for each module. The use of the term “module” as used herein with respect to components of the apparatus should therefore be understood to include particular hardware configured to perform the functions associated with the particular module as described herein.

The term “module” should be understood broadly to include hardware and, in some embodiments, software for configuring the hardware. For example, in some embodiments, “module” may include processing circuitry, storage medium, network interfaces, input/output devices, and the like. In some embodiments, other elements of the apparatus 200 may provide or supplement the functionality of a particular module, or particular modules. For example, the processor 202 may provide processing functionality, the memory 204 may provide storage functionality, the communications module 206 may provide network interface functionality, and the like.

In some embodiments, the processor 202 (and/or co-processor and any other processing module assisting or otherwise associated with the processor) may be in communications with the memory 204 via a bus for passing information among components of the apparatus. The memory 204 may be non-transitory and may include, for example, one or more volatile and/or non-volatile memories. In other words, for example, the memory may be an electronic storage device (e.g., a computer readable storage medium). The memory 204 may be configured to store information, data, content, applications, instructions, or the like, for enabling the apparatus to carry out various functions in accordance with example embodiments of the present invention.

The processor 202 may be enabled in a number of different ways and may, for example, include one or more processing devices configured to perform independently. Additionally or alternatively, the processor may include one or more processors configured in tandem with a bus to enable independent execution of instructions, pipelining, and/or multithreading. The use of the term “processing module” may be understood to include a single core processor, a multi-core processor, multiple processors internal to the apparatus, and/or remote or “cloud” processors.

In an example embodiment, the processor 202 may be configured to execute instructions stored in the memory 204 or otherwise accessible to the processor. Additionally or alternatively, the processor may be configured to execute hard-coded functionality. As such, whether configured by hardware or software methods, or by a combination thereof, the processor may represent an entity (e.g., physically embodied in the circuitry) capable of performing operations according to an embodiment of the present invention while configured accordingly. Alternatively, as another example, when the processor is embodied as an executor of software instructions, the instructions may specifically configure the processor to perform the algorithms and/or operations described herein when the instructions are executed.

In some embodiments, the apparatus 200 may include input/output module 208 that may, in turn, be in communication with processor 202 to provide output to the user and, in some embodiments, to receive an indication of a user input. The input/output module 208 may comprise a user interface and may include a display and may comprise a web user interface, a mobile application, a client device, a kiosk, or the like. In some embodiments, the input/output module 208 may also include a keyboard, a mouse, a touch screen, touch areas, soft keys, a microphone, a speaker, or other input/output mechanisms. The processor and/or user interface module comprising the processor may be configured to control one or more functions of one or more user interface elements through computer program instructions (e.g., software and/or firmware) stored on a memory accessible to the processor (e.g., memory 204, and/or the like).

The communications module 206 may be any means such as a device or circuitry embodied in either hardware or a combination of hardware and software that is configured to receive and/or transmit data from/to a network and/or any other device, circuitry, or module in communication with the apparatus 200. In regard, the communications module 206 may include, for example, a network interface for enabling communications with a wired or wireless communication network. For example, the communication module may include one or more network interface cards, antennae, buses, switches, routers, modems, and supporting hardware and/or software, or any other device suitable for enabling communications via a network. Additionally or alternatively, the communications interface may include the circuitry for interacting with the antenna(s) to cause transmission of signals via the antenna(s) or to handle receipt of signals received via the antenna(s).

In some embodiments, accounting module 210, authentication module 212, policy engine 214, and/or interface module 216 may also or instead be included and configured to perform the functionality discussed herein related to providing promotion redemptions, a merchant interface, a fulfillment party interface, and a consumer interface. In some embodiments, some or all of the functionality of accounting module 210, authentication module 212, policy engine 214, and/or interface module 216 may be performed by processor 202. In this regard, the example processes and algorithms discussed herein can be performed by at least one of processor 202, accounting module 210, authentication module 212, policy engine 214, and/or interface module 216. For example, non-transitory computer readable storage media can be configured to store firmware, one or more application programs, and/or other software, which include instructions and other computer-readable program code portions that can be executed to control processors of the components of apparatus 200 to implement various operations, including the examples shown herein. As such, a series of computer-readable program code portions may be embodied in one or more computer program products and can be used, with a device, server, database, and/or other programmable apparatus, to produce the machine-implemented processes discussed herein.

In an example embodiment, the database 112 contains information concerning individual payees (e.g., third-party entities, for example, operating third-party entity devices), such as any of: payee name, account number, credit card number, payee bank routing ID, payee bank account ID, and the like, that has been provided to the authentication and redemption system 108. The accounting module 210 accurately records, tracks and accounts for the funds that are in each of the user accounts and also handles the account reconciliation that occurs when a redemption code is dispense or payments to the fulfillment parties are authorized.

The authentication module 212 includes hardware, software, or a combination thereof, for receiving signals, data objects, or the like, for processing received signals to authenticate the identity of a recipient device 104 and/or user associated with a recipient device 104. For example, the authentication module 212 may include hardware, software, or a combination thereof for receiving and/or identifying device identification information, device location data, and/or the like from received signals and/or information received from a recipient device 104. Additionally or alternatively, the authentication module 212 may include hardware, software, or a combination thereof, for retrieving and/or identifying stored information utilized to authenticate the identity of a recipient device 104 and/or user associated with a recipient device 104, for example stored proximity data, and/or the like. Additionally or alternatively, the authentication module 212 may include hardware, software, or a combination thereof, for processing the received and/or identified information from the recipient device 104 with the retrieved and/or identified stored information. In this regard, the authentication module 212 may analyze the data to determine whether to authenticate a particular recipient device 104 and/or user associated with a particular recipient device 104, and to generate and/or transmit a corresponding signal, error message, or combination thereof. In some embodiments, authentication module 212 may include software, hardware, or a combination thereof to make a determination as to whether the received and retrieved data matches, and generate one or more signals based on the determination.

It should be appreciated that, in some embodiments, the authentication module 212 performs one or more of the aforementioned operations alone, or in combination with one or more other modules of the apparatus 200. For example, in some embodiments, the authentication module 212 may leverage the processor 202 for processing functionality and the communications module 206 for data reception functionality. In yet some embodiments, the authentication module 212 may include a separate processor, specially configured field programmable gate array (FPGA), or specially configured application specific integrated circuit (ASIC). The authentication module 212 is configured, in some embodiments, to perform one or more additional and/or alternative functions, and/or partial operations or whole operations described with respect to one or more other modules as illustrated.

Apparatus 200 may also include a policy engine 214 that allows a merchant to define one or more redemption policies. The policy engine 214 preferably is coupled with an interface module 216 that includes a graphical user interface that simplifies the task of the third-party entity defining the redemption policies. A redemption code may include criteria (i.e., one or more conditions) that must be satisfied for redemption code to be redeemed by a consumer. The interface module 216 may include a wizard that queries the third-party entity for the information needed to define a redemption policy. The policy engine 214 reads the redemption code records, reads the qualification requirement, redemption policy information or criteria in the redemption policies, and determines whether determined identification information and/or activity information from the recipient device 104 in the index advice records 340 satisfies the criteria specified in one or more of the redemption policies issued by the third-party entity. If the redemption policy is satisfied, the authorized recipient may redeem the redemption code.

As described above and as will be appreciated based on this disclosure, embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

### Example Operations for Implementing Embodiments of the Present Invention

Having thus described an example system and example apparatuses, an example data flow will now be described. It will be appreciated that the described data flows, operations and/or, processes therein, and the like, are non-limiting examples, and embodiments may perform various data flows, processes, and/or operations in a myriad of ways using various system configurations.

Operations for Authenticating Users with the Authentication and Redemption System

FIG. 3 depicts an example data flow illustrating interactions between a third-party entity device 102, a recipient device 104, a network provider 301, an authentication and redemption system 108, and a fulfillment party 106. The data flow 300 illustrates how electronic information may be passed among various systems in accordance with embodiments of the present invention. In particular, FIG. 3 depicts data flow operations for an authentication process, the authentication process configured to receive identification information of an intended recipient from a third-party entity, and based on determining a match of the identification information of the intended recipient to that of a redeeming device, prompting a fulfillment party 106 to provide access or deny access to one or more services.

Initially, a third-party entity 102 may provide an authentication and redemption system 108 with information indicative of an intent to provide payment (e.g., in full, or partially) for a particular service (e.g., a particular fulfillment entity may be indicated) and any qualification requirements (e.g., identification information of a mobile device associated the intended recipient, time limits, etc.), resulting in the third-party entity or the authentication and redemption system providing the mobile device associated with the intended recipient (hereinafter, the intended recipient) with an electronic communication comprising at least the redemption code, and in some embodiments, information indicative of any qualification requirements. In particular, at step 301, third-party entity device 102 transmits a redemption code creation request communication message to the authentication and redemption system 108. In the depicted example, the redemption code creation request comprises at least one qualification requirement and redemption code policy information that are structured for receipt by the authentication and redemption system 108 as shown by step 302. The redemption code redemption policy information may relate to any information regarding the intended recipient or context of the intended recipient, such as information detected via the recipient device 104. For example, a qualification requirement may be indicative of location data and may include a requirement such as, “the consumer must be located within a mile radius of the third-party entity at the time of redemption.” In some embodiments, the at least one qualification requirement may comprise each of a plurality of data elements such as, for example, a phone number, a name, a location (GPS related, a billing address, or the like), a device serial number, a unique serial number (ICCID), an international mobile subscriber identity (IMSI) number, and/or an International Mobile Equipment Identity (IMEI).

As shown by step 303, the recipient device 104 may attempt to redeem a redemption code. The fulfillment party 106 receives the attempt to redeem the redemption code as shown by step 304. The fulfillment party 106, requiring authentication, then at step 305 transmits an authorization request to the authentication and redemption system 108. In step 306, the authentication and redemption system 108 receives the authorization request from the fulfillment party 106 indicating that a device 104 is attempting to redeem a redemption code, and requesting authorization for the device 104 to redeem the redemption code. The authentication and redemption system 108 may then request authentication of the recipient device 104. In an exemplary embodiment, the authentication and redemption system 108 may perform an authentication process that comprises providing a network address to the recipient device 104 as shown by step 307. Upon the recipient device 104 accessing the network address (step 308), the authentication and redemption system 108 receives an identification parameter as shown in step 309, which may include, for example, identification information, such as the phone number of the device that accessed the network address. In step 310, the authentication and redemption system 108 may then perform a matching process, for example, between the identification parameter initially provided by the third-party entity identifying an intended recipient and the identification parameter received as a result of the recipient device 104 accessing the network address, to determine whether the identification parameter satisfies the at least one qualification requirement. In an example embodiment, determining whether the identification parameter satisfies the qualification requirement comprises determining whether the identification parameter is associated with the consumer identifier set by the third-party entity and stored on the authentication and redemption system 108. In step 311, the authentication and redemption system 108 may then prompt the fulfillment party 106 to allow or deny redemption of the promotion. Allowing or denying redemption of the promotion may be based on the determination whether the identification parameter satisfies the at least one qualification requirement and as follows the fulfillment party 106 may allow or deny redemption of the promotion as shown by step 312.

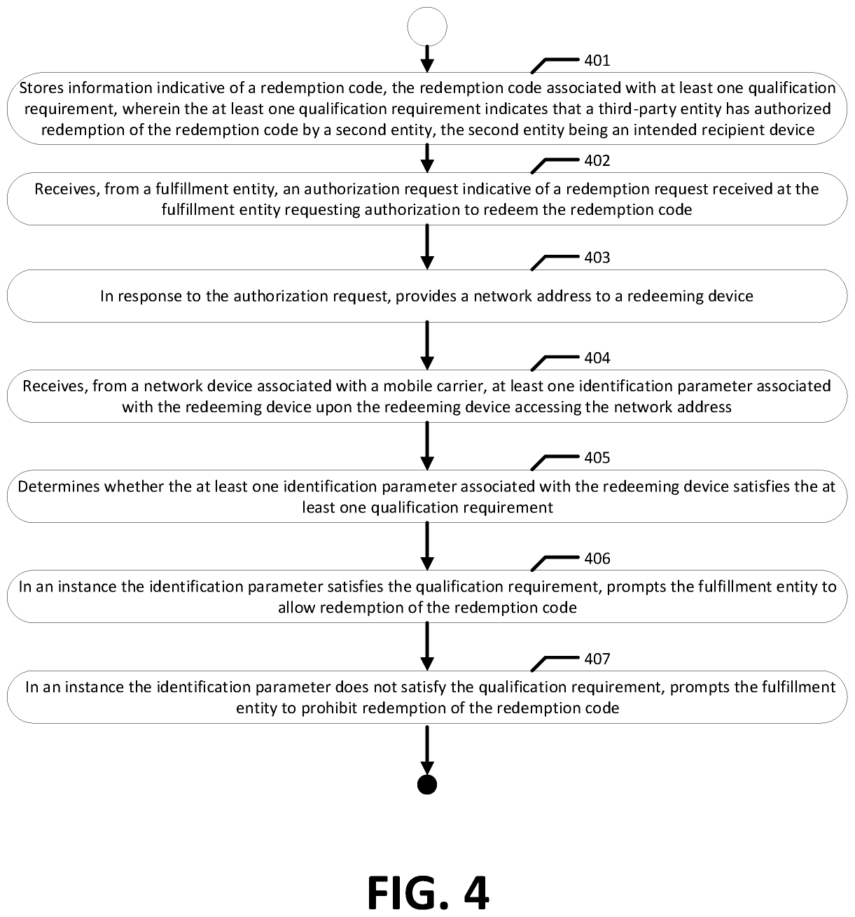

Turning now to FIG. 4, a set of operations performed by server 110 in accordance with an exemplary embodiment of the present invention will be described. At block 401, the server 110 stores information indicative of a redemption code, the redemption code associated with at least one qualification requirement, wherein the at least one qualification requirement indicates that a third-party entity has authorized redemption of the redemption code by a second entity, the second entity being an intended recipient device. At block 402, the server 110 receives, from a fulfillment entity, an authorization request indicative of a redemption request received at the fulfillment entity requesting authorization to redeem the redemption code. In block 403, the server 110 may in response to the authorization request, provide a network address to a redeeming device. In some embodiments, the network address is a uniform resource locator (URL) address. In block 404, the server 110 receives, for example, from a network device associated with a mobile carrier, at least one identification parameter associated with the redeeming device upon the redeeming device accessing the network address. In some embodiments, the at least one qualification requirement and the at least one identification parameter is at least one of a telephone number, a device serial number, a unique serial number (ICCID), an international mobile subscriber identity (IMSI) number, an International Mobile Equipment Identity (IMEI), or a location of the second entity.

The server 110 may then, as shown in block 405, determine whether the at least one identification parameter associated with the redeeming device satisfies the at least one qualification requirement. For example, the determination may include evaluating some Boolean conditions to determine whether or not a consumer and/or a redeeming device belongs to a specified group, as indicated by the authentication module 212 and policy engine 214. For example, in an exemplary embodiment, the determination may include determining whether the value of the identification parameter received, for example, from the network device associated with a mobile carrier, is associated with at least one of a plurality of authorized recipient identifiers as provided by the third-party entity. As another example, additionally or alternatively, the determination may include determining if the redeeming device is within a specified distance of the third-party entity.

In an instance the identification parameter satisfies the qualification requirement, the server 110 prompts the fulfillment entity to allow redemption of the redemption code as shown by block 406. In an instance the identification parameter does not satisfy the qualification requirement, the server 110 prompts the fulfillment entity to prohibit redemption of the redemption code as shown by block 407. In another example embodiment, the server 110 may be configured to receive redemption policy information from the third-party entity and determine whether to prompt the fulfillment entity to allow redemption of the redemption code or prohibit redemption of the redemption code based at least in part on the redemption policy information set by the third-party entity, wherein the redemption policy information set by the third-party entity comprises any of a time frame and/or geographic location within which the redemption code may be redeemed. For example, the redemption policy information may be indicative on geographic location data, such as the geographic location of the redeeming entity being in a specified location and/or within a specified distance of the third-party entity. In another example embodiment, the redemption policy information may require redemption of the promotion within a fixed time period.

In yet another example embodiment, the server 110 may upon prompting the fulfillment entity to allow redemption of the redemption code, access payment information associated with the third-party entity and process a payment transaction using the payment information, wherein payment will be made to the fulfillment entity on behalf of the intended recipient. A third-party entity may establish an account with the authentication and redemption system 108 to enroll in pre-payment, automatic payments, or the like. Specifically, the authentication and redemption system 108 is authorized by the third-party entity to make payments to the fulfillment party 106 on behalf of the intended recipient upon redemption of a redemption code.

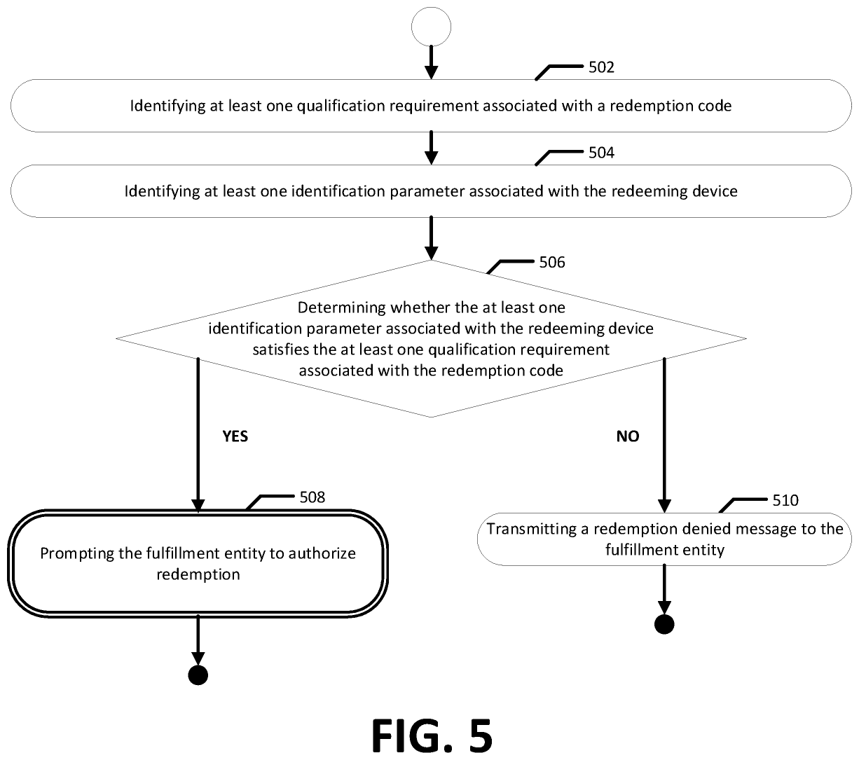

FIG. 5 illustrates one example authentication process that may be used in some embodiments. For example, in some embodiments, the process described with respect to FIG. 5 may embody a sub-process for performance as one authentication process in authentication of a consumer identity associated with a mobile device or device identity. It should be understood that, in some embodiments, the authentication process described with respect to FIG. 5 may be combined with one or more authentication processes with associated operations performed in any combination, order, and/or the like. The example process may provide a specific computer-implemented method to be performed by specially configured hardware and/or software, for example performed by the apparatus 200 shown in FIG. 2.

At block 502, the apparatus 200 includes means, such as processor 202, and/or the like, or a combination thereof, configured to identify at least one qualification requirement associated with a redemption code. The at least one qualification requirement, in some embodiments, may be stored by the apparatus 200. At block 504, the apparatus 200 includes means, such as processor 202, and/or the like, or a combination thereof, configured to identify at least one identification parameter associated with the redeeming device. The at least one identification parameter may include a phone number in plain-text, and/or a phone number in hashed form, such that a redeeming device (e.g., mobile device) is authenticated if the identification parameter associated with the redeeming device satisfies the at least one qualification requirement associated with the redemption code (e.g., has the same value of the identification parameter, such as the same phone number, indicating that the redeeming device is the intended recipient).

At determination block 506, the apparatus 200 includes means, such as processor 202, and/or the like, or a combination thereof, configured to determine whether the at least one identification parameter associated with the redeeming device satisfies the at least one qualification requirement associated with the redemption code. In an example embodiment, the apparatus 200 includes means, such as processor 202 and/or the like, or a combination thereof, configured to compare the at least one qualification requirement associated with the redemption code and the at least one identification parameter associated with the redeeming device. In some such embodiments, the apparatus 200 is configured to perform a direct comparison between the at least one qualification requirement associated with the redemption code and the at least one identification parameter associated with the redeeming device. In other embodiments, the apparatus 200 is configured to perform one or more un-encryption or other transformation operations on the at least one qualification requirement associated with the redemption code and/or the at least one identification parameter associated with the redeeming device before performing the comparison. Additionally or alternatively, in some embodiments, the apparatus 200 may implement one or more APIs for performing the comparison between the at least one qualification requirement associated with the redemption code and the at least one identification parameter associated with the redeeming entity. Note that in some embodiments, for example, where privacy is requested or desired, the authentication and redemption system may be provided with a hash or otherwise encrypted information from one or both the third-party entity and network device. In those embodiments in which the third-party entity provides encrypted information to the authentication and redemption system, for example to avoid having identification information being stored in association with particular services, goods, etc., the third-party may either provide the encryption algorithm to the authentication and redemption system such that the identification information of the redeeming device may be encrypted using the encryption algorithm and the hashes of both may be compared or the like.

If, at block 506, the apparatus 200 determines the at least one identification parameter associated with the redeeming device does not satisfy the at least one qualification requirement associated with the redemption code, flow continues to block 510. At block 510, the apparatus 200 includes means, such as processor 202, and/or the like, configured to transmit a redemption denied message to the fulfillment entity (e.g., the fulfillment party 106). The message may be embodied by, or include, an indication that the at least one identification parameter does not match or does not satisfy the at least one qualification requirement associated with the redemption code.

If, at block 506, the apparatus 200 determines the at least one identification parameter associated with the redeeming device does satisfy the at least one qualification requirement associated with the redemption code, the apparatus 200 may continue processing at block 508. At block 508, the apparatus 200 includes means, such as processor 202, and/or the like, configured to prompt the fulfillment entity to authorize redemption.

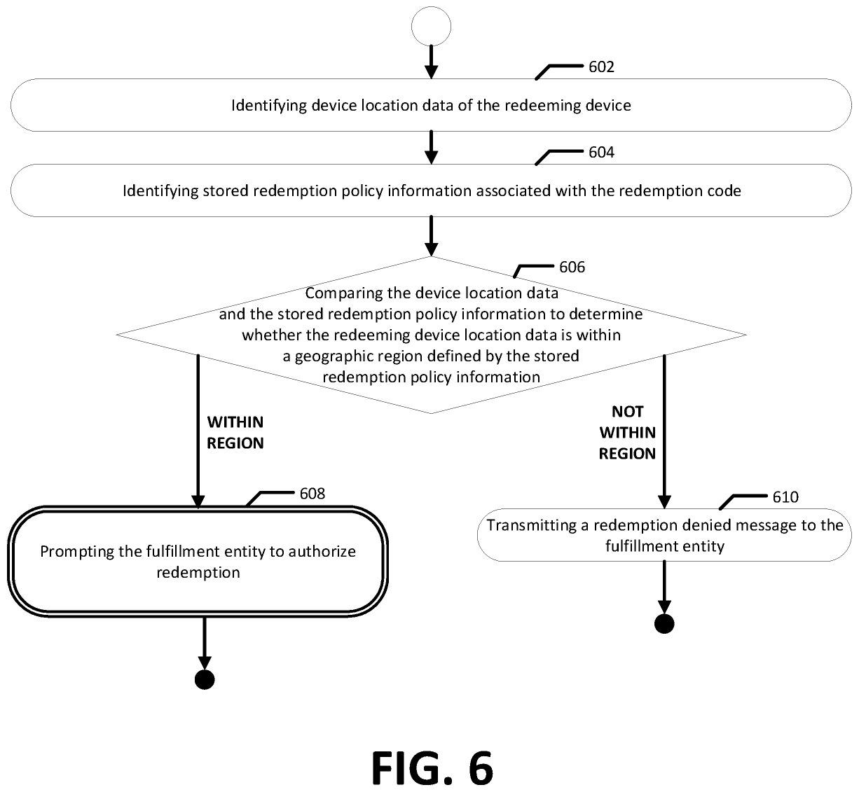

FIG. 6 illustrates yet another example authentication process that may be used in some embodiments. For example, in some embodiments, the process described with respect to FIG. 6 may embody a sub-process for performance as one authentication process in authentication of a user identity associated with a mobile device or device identity. It should be understood that, in some embodiments, the authentication process described with respect to FIG. 6 may be combined with one or more authentication processes with associated operations performed in any combination, order, and/or the like. The example process may provide a specific computer-implemented method to be performed by specially configured hardware and/or software, for example performed by the apparatus 200. Application Ser. No. 15/549,662, entitled “Method and Apparatus for Frictionless Custody Management,” filed on Aug. 23, 2019, which is hereby incorporated by reference in its entirety, describes a number of exemplary authentication processes for performing a location confirmation authentication process.

At block 602, the apparatus 200 includes means, such as processor 202, configured to identify device location data associated with the redeeming device. It should be appreciated that the device location data may be in any of a myriad of formats and embody a myriad of location types, for example, without limitation, a latitude and longitude coordinate, triangulation data from a network provider or another entity associated with the client device, an address, a zip code, a region-identifier determined by the apparatus 200 based on one or more previous actions, and/or the like. The device location data, in some embodiments, may be stored by the redeeming device, and retrieved for transmission to the apparatus 200. Additionally or alternatively, in some embodiments, the apparatus 200 may detect, collect, and/or transmit the device location data in real-time, for example using location services hardware and/or software associated with the device.

At block 604, the apparatus 200 includes means, such as processor 202, configured to identify stored redemption policy information associated with the redemption code. The stored redemption policy information may include data representing one or more geographic areas indicative of instructions that if the redeeming device is authenticated if device location associated with the redeeming device is within one of the geographic areas. For example, in some embodiments, the stored redemption policy information may include an approved location indicator and a radius, such that the stored proximity data represents a certain radius around the approved location. In some embodiments, the stored redemption policy information comprises a plurality of location boundary data objects, such that the stored proximity data represents an enclosed geographic area defined by the plurality of location boundary data objects.

In some embodiments, to identify the stored redemption policy information associated with the redemption code, the apparatus 200 is configured to retrieve the stored redemption policy information from a database or other repository. The stored redemption policy information may be retrieved based on redemption code identification information, for example where the stored redemption policy information is stored to a database associated with certain redemption code identification information. In some such embodiments, the apparatus 200 identifies stored redemption policy information using one or more database queries. For example, in some embodiments, the apparatus 200 is configured to query a database using identified redemption code identification information and/or other information received and/or associated with a redemption code. The apparatus 200 may, in response to the query, receives result data including the stored redemption policy information associated with the redemption code identification information, and therefore associated with the redemption policies.

At determination block 606, the apparatus 200 includes means, such as processor 202, configured to compare the device location data and the stored redemption policy information to determine whether the redeeming device location data is within a geographic region defined by the stored redemption policy information. In some embodiments, the apparatus 200 may utilize one or more application programming interfaces (APIs) to compare the device location data and the stored redemption policy information, wherein such one or more API(s) are configured to output the determination. Alternatively, in some embodiments, the apparatus 200 is configured to perform one or more range checks, for example a range check between the redeeming device location data and location data included in the stored redemption policy information, to output the determination as to whether the redeeming device location data satisfies a range threshold included in or associated with the geographic area defined by the stored redemption policy information (for example, the redeeming device location data is within the geographic area is less than the range threshold distance from a particular stored location identified in the stored redemption policy information). It should be appreciated that, in other embodiments, one or more additional and/or alternative algorithms may be used to determine whether the redeeming device location data is within the geographic region defined by the stored redemption policy information.

If, at block 606, the apparatus 200 determines the location data is not within the geographic region defined by the stored redemption policy information, flow continues to block 610. At block 610, the apparatus 200 includes means, such as processor 202, configured to transmit a redemption denied message to the fulfillment entity. The message may be embodied by, or include, an indication that the redeeming device location data is not within the geographic region defined by the stored redemption policy information. Returning to block 606, if, at block 606, the apparatus 200 determines the redeeming device location data is within the geographic region defined by the stored redemption policy information, the apparatus 200 may continue processing at block 608. At block 608, the apparatus includes means, such as processor 202, configured to prompt the fulfilling party to authorize redemption.

### Use Cases

In an example embodiment of the present invention, an apparatus or computer program product may be provided to implement or execute a method, process, or algorithm for facilitating frictionless authentication in the attempted redemption of a redemption code issued by a third-party entity and fulfilled by a fulfillment entity.

Here, the third-party entity, for example, operating a device with a mobile app installed thereon with a particular purpose (e.g., scheduling a car ride service) opens the app, which may or may not require login credentials. Once logged in, the third-party entity may then cause transmission of or request transmission of redemption code information and payment information to the authentication and redemption system 108. As such, as described herein, the authentication and redemption system 108 receives the redemption code information which is used to authenticate a redeeming device, or in some example, a device attempting to use the promotion to schedule a car ride service. When a consumer attempts to use the redemption code for the car ride service, the fulfillment party providing the car ride service wants to authenticate the consumer before providing the free car ride service. Using the above-mentioned authentication processes, the authentication and redemption system 108 may detect the consumer's phone number, then instantly and automatically prompt the fulfillment party to allow the redemption transaction. In another example embodiment, the authentication and redemption system 108 may issue a payment to the car ride service for providing its service.

FIGS. 3-6 show data flows or flowcharts (hereinafter, flowcharts) of the exemplary operations performed by a method, apparatus and computer program product in accordance with embodiments of the present invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 204 of an apparatus employing an embodiment of the present invention and executed by a processor 202 in the apparatus 200. As will be appreciated, any such computer program instructions may be loaded onto a computer or other programmable apparatus (for example, hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIGS. 3-6 when executed, convert a computer or processing circuitry into a particular machine configured to perform an example embodiment of the present invention. Accordingly, the operations of FIGS. 3-6 define an algorithm for configuring a computer or processing to perform an example embodiment. In some cases, a general purpose computer may be provided with an instance of the processor which performs the algorithms of FIGS. 3-6 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations herein may be unnecessary, modified or further amplified. It should be appreciated that each of the modifications, optional operations or amplifications may be included with the operations either alone or in combination with any others among the features described herein.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A computer-implemented method comprising:
storing information indicative of a redemption code, the redemption code associated with at least one qualification requirement, wherein the at least one qualification requirement indicates that a third-party entity has authorized redemption of the redemption code by a second entity, the second entity being an intended recipient device;
receiving, from a fulfillment entity, an authorization request indicative of a redemption request received at the fulfillment entity requesting authorization to redeem the redemption code;
in response to the authorization request, providing a network address to a redeeming device;
receiving, from a network device associated with a mobile carrier, at least one identification parameter associated with the redeeming device upon the redeeming device accessing the network address;
determining whether the at least one identification parameter associated with the redeeming device satisfies the at least one qualification requirement;
in an instance the identification parameter satisfies the qualification requirement, prompting the fulfillment entity to allow redemption of the redemption code; and
in an instance the identification parameter does not satisfy the qualification requirement, prompting the fulfillment entity to prohibit redemption of the redemption code.

2. The method according to claim 1, wherein the at least one qualification requirement and the at least one identification parameter is at least one of a telephone number, a device serial number, a unique serial number (ICCID), an international mobile subscriber identity (IMSI) number, an International Mobile Equipment Identity (IMEI), or a location of the second entity.

3. The method according to claim 1, wherein the network address is a uniform resource locator (URL) address.

4. The method according to claim 1, further comprising:
receiving redemption policy information from the third-party entity; and
determining whether to prompt the fulfillment entity to allow redemption of the redemption code or prohibit redemption of the redemption code based at least in part on the redemption policy information set by the third-party entity.

5. The method according to claim 4, wherein the redemption policy information set by the third-party entity comprises a time frame and/or geographic location within which the redemption code can be redeemed.

6. The method according to claim 1, further comprising:
upon prompting the fulfillment entity to allow redemption of the redemption code, accessing payment information associated with the third-party entity; and
processing a payment transaction using the payment information associated with the third-party entity, wherein payment will be made to the fulfillment entity on behalf of the intended recipient.

7. The method according to claim 1, wherein determining whether the identification parameter associated with the redeeming device satisfies the qualification requirement further comprises:
performing a matching process between the qualification parameter provided by the third-party entity identifying the intended recipient and the identification parameter associated with the redeeming device upon the redeeming device accessing the network address.

8. An apparatus comprising at least one processor and at least one memory including computer program code, the at least one memory and the computer program code configured to, with the processor, cause the apparatus to at least:
store information indicative of a redemption code, the redemption code associated with at least one qualification requirement, wherein the at least one qualification requirement indicates that a third-party entity has authorized redemption of the redemption code by a second entity, the second entity being an intended recipient device;
receive, from a fulfillment entity, an authorization request indicative of a redemption request received at the fulfillment entity requesting authorization to redeem the redemption code;
in response to the authorization request, provide a network address to a redeeming device;
receive, from a network device associated with a mobile carrier, at least one identification parameter associated with the redeeming device upon the redeeming device accessing the network address;
determine whether the at least one identification parameter associated with the redeeming device satisfies the at least one qualification requirement;
in an instance the identification parameter satisfies the qualification requirement, prompt the fulfillment entity to allow redemption of the redemption code; and
in an instance the identification parameter does not satisfy the qualification requirement, prompt the fulfillment entity to prohibit redemption of the redemption code.

9. The apparatus according to claim 8, wherein the at least one qualification requirement and the at least one identification parameter is at least one of a telephone number, a device serial number, a unique serial number (ICCID), an international mobile subscriber identity (IMSI) number, an International Mobile Equipment Identity (IMEI), or a location of the second entity.

10. The apparatus according to claim 8, wherein the network address is a uniform resource locator (URL) address.

11. The apparatus according to claim 8, wherein the at least one memory and the computer program code are further configured to, with the processor, cause the apparatus to:
receive redemption policy information from the third-party entity; and
determine whether to prompt the fulfillment entity to allow redemption of the redemption code or prohibit redemption of the redemption code based at least in part on the redemption policy information set by the third-party entity.

12. The apparatus according to claim 11, wherein the redemption policy information set by the third-party entity comprises a time frame and/or geographic location within which the redemption code can be redeemed.

13. The apparatus according to claim 8, wherein the at least one memory and the computer program code are further configured to, with the processor, cause the apparatus to:
upon prompting the fulfillment entity to allow redemption of the redemption code, access payment information associated with the third-party entity; and
process a payment transaction using the payment information associated with the third-party entity, wherein payment for the redemption code will be made to the fulfillment entity on behalf of the intended recipient.

14. The apparatus according to claim 8, wherein determining whether the identification parameter associated with the redeeming device satisfies the qualification requirement further causes the apparatus to:
perform a matching process between the qualification parameter provided by the third-party entity identifying the intended recipient and the identification parameter associated with the redeeming device upon the redeeming device accessing the network address.

15. A computer program product comprising at least one non-transitory computer-readable storage medium having computer-executable program code instructions stored therein, the computer-executable program code instructions comprising program code instructions for:
storing information indicative of a redemption code, the redemption code associated with at least one qualification requirement, wherein the at least one qualification requirement indicates that a third-party entity has authorized redemption of the redemption code by a second entity, the second entity being an intended recipient device;
receiving, from a fulfillment entity, an authorization request indicative of a redemption request received at the fulfillment entity requesting authorization to redeem the redemption code;
in response to the authorization request, providing a network address to a redeeming device;
receiving, from a network device associated with a mobile carrier, at least one identification parameter associated with the redeeming device upon the redeeming device accessing the network address;
determining whether the at least one identification parameter associated with the redeeming device satisfies the at least one qualification requirement;
in an instance the identification parameter satisfies the qualification requirement, prompting the fulfillment entity to allow redemption of the redemption code; and
in an instance the identification parameter does not satisfy the qualification requirement, prompting the fulfillment entity to prohibit redemption of the redemption code.

16. The computer program product according to claim 15, wherein the at least one qualification requirement and the at least one identification parameter is at least one of a telephone number, a device serial number, a unique serial number (ICCID), an international mobile subscriber identity (IMSI) number, an International Mobile Equipment Identity (IMEI), or a location of the second entity.

17. The computer program product according to claim 15, wherein the network address is a uniform resource locator (URL) address.

18. The computer program product according to claim 15, wherein the computer-executable program code instructions further comprise program code instructions for:
receiving redemption policy information from the third-party entity; and
determining whether to prompt the fulfillment entity to allow redemption of the redemption code or prohibit redemption of the redemption code based at least in part on the redemption policy information set by the third-party entity.

19. The computer program product according to claim 18, wherein the redemption policy information set by the third-party entity comprises a time frame and/or geographic location within which the redemption code can be redeemed.

20. The computer program product according to claim 15, wherein the computer-executable program code instructions further comprise program code instructions for:
upon prompting the fulfillment entity to allow redemption of the redemption code, accessing payment information associated with the third-party entity; and
processing a payment transaction using the payment information associated with the third-party entity, wherein payment will be made to the fulfillment entity on behalf of the intended recipient.
